(19) United States
(12) Patent Application Publication
(10) Pub. No.: US 2022/0230520 A1
(43) Pub. Date: Jul. 21, 2022

(54) SYSTEM AND METHOD FOR DETECTING AND RESPONDING TO PREMISES SERIAL ACTIVE-SHOOTER EVENTS

(71) Applicant: Luis OSORIO, Jersey City, NJ (US)

(72) Inventor: Luis OSORIO, Jersey City, NJ (US)

(21) Appl. No.: 16/535,056

(22) Filed: Aug. 7, 2019

(51) Int. Cl. G08B 21/02; G06F 3/14; G08B 15/00; G08B 25/00

(52) U.S. Cl. CPC G08B 21/02; G08B 25/00; G08B 15/00; G06F 3/14

(57) ABSTRACT

A method for responding to an active-shooter event comprising the steps of: providing a module in each room and each designated area of a premises being monitored, said module being monitored and controlled by a remote computer/communications/control system; each module providing: audible alarm means and audio sensing means; said control system remotely configuring each module to display via a monitor a “left exit” command; a “right exit” command; a “window exit” command; and any other command in response to an active-shooter event detected by a module known as the activated module; upon such activated module detecting such active-shooter event then activating said audible alarm means in the rooms and the designated areas; and said control system transmitting to law enforcement a unique code allowing law enforcement to enter said control system and allowing law enforcement to monitor and assess said activated module.

### BACKGROUND OF THE INVENTION

### 1. Field of the Invention

This invention relates to a system and method for detecting premises serial active-shooter events and in particular to such a system and method for responding to such events.

### 2. Description/Discussion of the Prior Art

The following are relevant prior art patent references:

A review of the above-cited patent references reveals that such references do not appear to disclose applicant's claimed invention.

### SUMMARY OF THE PRESENT INVENTION

Separate rooms or designated areas of the premises are each provided with a module being monitored and controlled by the remote computer/communications system.

Each module comprises: an audible alarm; video sensing means; audio sensing means; and motion sensing means. Each module may be remotely configured bu the control system to project or display via a screen or a monitor a “left exit” command; a “right exit” command; and/or a “window exit” command.

In a first configuration, a module may display a “left exit” command; a “right exit” command; and a “window exit” command.

In a second configuration, a module may display a “window exit only” command.

In a third configuration, a module may display a “right exit” command; and a “window exit” command.

In a fourth configuration, a module may display a “left exit” command; and a “window exit” command.

In a fifth configuration, a module may display a “stay in room” configuration.

A module's audio sensing means in conjunction with the computer/communications/control system may detect a first active-shooter event in a first room or first designated area. In such case such module will be activated by the computer/communications/control system into a configuration for alerting and directing the occupants of such first room or first designated area. Simultaneously, the computer/communications/control system will activate modules in other rooms and other designated areas into other configurations as previously programmed for optimum speed and safety. Simultaneously, the audible alarms in the rooms and designated areas are activated by the control system.

A second module's audio sensing means in conjunction with the computer/communications/control system may detect a second active-shooter event in a second room or second designated area. In that case such second module will be activated by the computer/communications/control system into a configuration for alerting and directing the occupants of such second room or second designated area. Simultaneously, the computer/communications/control system will activate modules in other rooms or other designated areas into other configurations as previously programmed for optimum speed and safety. Simultaneously, the alarms in the rooms and the designated areas are activated.

All modules are connected to the control system via bi-directional wired or wireless communications means. Further, the control system is connected via bi-directional wired or wireless communications means to law enforcement. The aforementioned configurations of the modules may change as the active-shooter events progress physically throughout the premises. Such progression of active-shooter events are detected by the respective proximate modules in order and such detections are transmitted in order to the control system. In turn, the control system receives such serial module detections and effects changes in the module configurations as pre-programmed in the control system. Upon the detection of each consecutive active-shooter event, the control system transmits a unique code to law enforcement via the communications means thereby allowing law enforcement to enter the control system and thereby allowing law enforcement monitor the latest active-shooter scene via the audio sensing means and the video sensing means of the latest activated module.

### Objects of the Present Invention are to

To provide occupants the latest directions and latest instructions to reach safety.

To provide law enforcement sequential information about progressing active-shooter events and allowing law enforcement to monitor serial active-shooter events.

Advantages of the present invention are that it provides instantaneous instructions and directions to premises occupants;

Provides instantaneous capability to law enforcement to monitor active-shooter events.

### BRIEF DESCRIPTION OF THE DRAWING

The above and other objects, advantages and features of the present invention will be better appreciated from a reading of the following detailed description in conjunction with the drawing in which:

FIG. 1 is a premises layout;

FIG. 2 is a first configuration of a module display;

FIG. 3 is a second configuration of a module display;

FIG. 4 is a third configuration of a module display;

FIG. 5 is a fourth configuration of a module display;

FIG. 6 shows that a first active-shooter event has occurred in room r101;

FIG. 7 shows that a second active-shooter event has occurred in room r110;

FIG. 8 shows that a third active-shooter event has occurred in room r115;

FIG. 9 shows that a fourth active-shooter event has occurred at end h101 of the hallway;

FIG. 10 shows that a fifth active-shooter event has occurred in the middle h110 of the hallway;

FIG. 11 shows that a sixth active-shooter event has occurred at end h115 of the hallway.

FIG. 12 shows the connections between modules m101 through m118, hm101 and hm115 to control system cs118 of room 118; and shows the connection between control system cs118 and law enforcement le118.

### DETAILED DESCRIPTION OF THE DRAWING

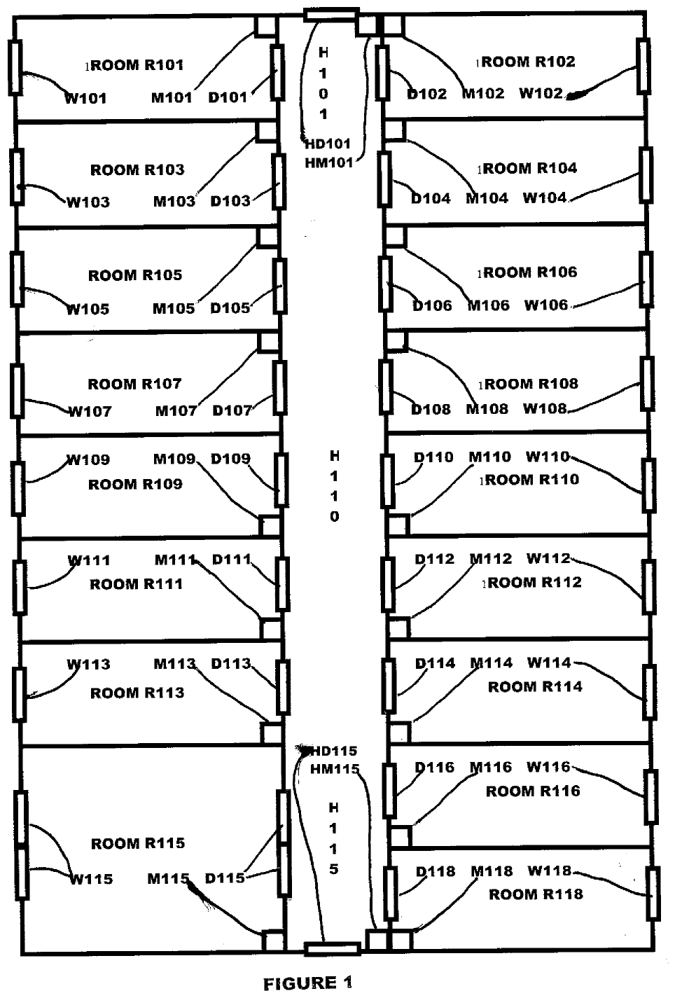

FIG. 1 shows a premises such as a school comprising rooms r101 through r118. Rooms r101 through r114 may be classrooms. Room r115 may be the school's office. Room116 may be the school's storage and file room. room r118 may be the school's equipment and computer/communication/control room. Rooms r101 through r118 respectively comprise: windows w101 through w118; doors d101 through d118; and modules m101 through m118.

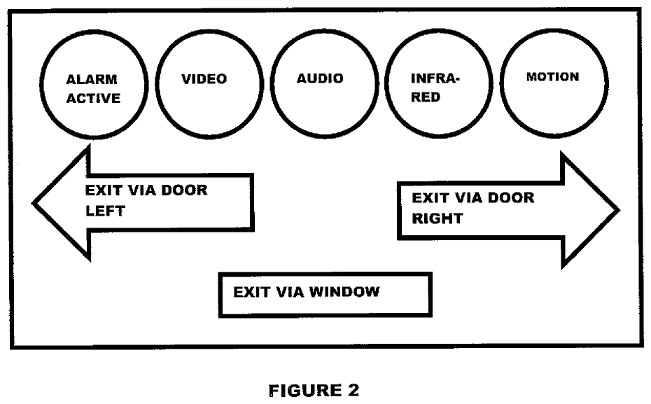

FIG. 2 is a first configuration of a module showing: an alarm; video sensing means; audio sensing means; and motion sensing means. As to such first configuration the module's front area monitor or screen displays a “left exit” command; a “right exit” command; and a “window exit” command. Such left and right commands may be left and right pointing arrows with black lettering and a blue fill for “code blue”.

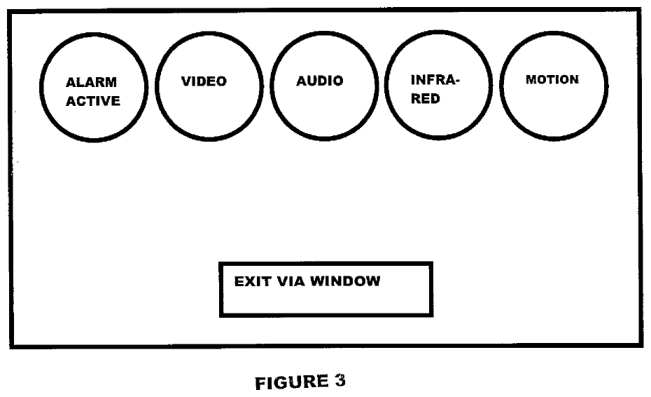

FIG. 3 is a second configuration of a module showing: an alarm; video sensing means; audio sensing means; and motion sensing means. As to such second configuration the module's front area monitor or screen displays a “window exit only” command.

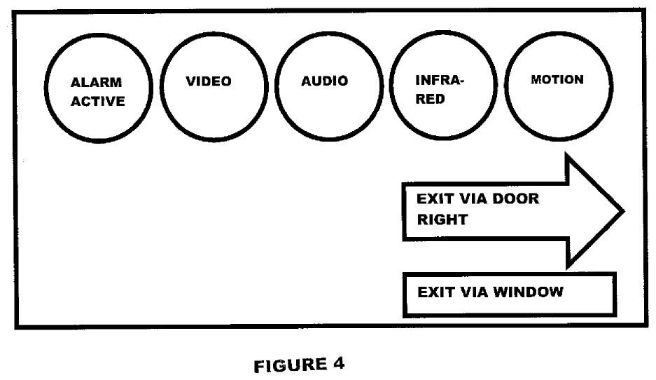

FIG. 4 is a third configuration of a module showing: an alarm; video sensing means; audio sensing means; and motion sensing means. As to such third configuration the module's front area monitor or screen displays a “right exit” command; and a “window exit” command.

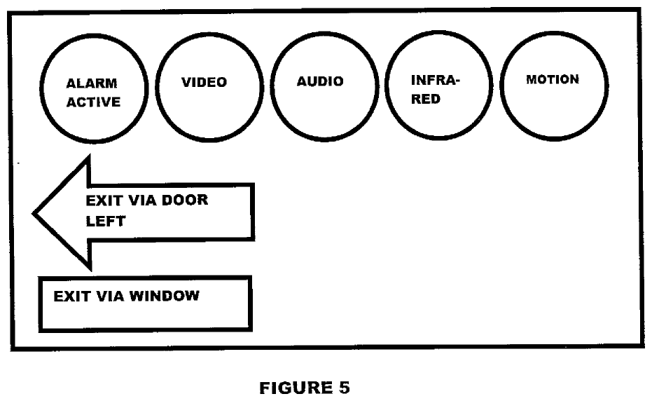

FIG. 5 is a fourth configuration of a module showing: an alarm; video sensing means; audio sensing means; and motion sensing means. As to such fourth configuration the module's front area monitor or screen displays a “left exit” command; and a “window exit” command. A fifth module configuration may display a “stay in room” command.

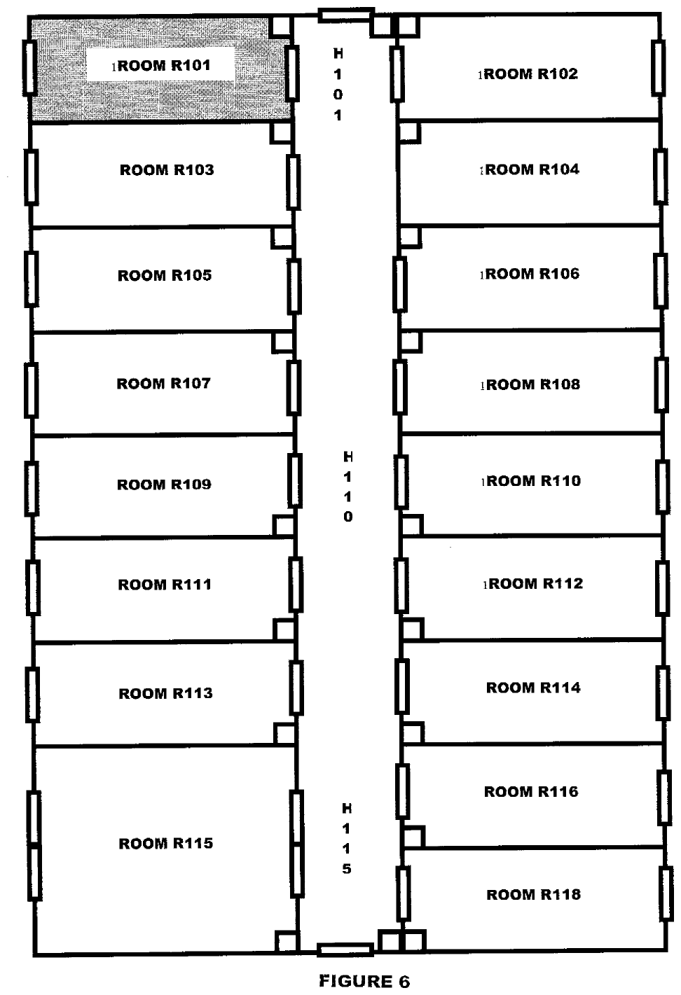

FIG. 6 shows the school premises and indicates that the audio sensing means of module m101 in conjunction with the computer/communication system of room r118 has detected a first active-shooter event in room r101. In such case module m101 is activated by the computer/communication system into the fourth configuration for alerting and directing the occupants of room r101. Simultaneously the computer/communication system activates module m102 of room r102 into the first configuration, the second configuration, the third configuration, or the fourth configuration as previously programmed for optimum speed and safety. Such configuration choice will be dictated by physical dimensions and other factors. simultaneously, the computer/communication system activates module m103 of room r103 into the first configuration or the third configuration as previously programmed for optimum speed and safety. Such configuration choice will be dictated by physical dimensions and other factors. Simultaneously the computer/communication system activates module m104 of room r104 into the second configuration or the fourth configuration as previously programmed for optimum speed and safety. Such configuration choice will be dictated by physical dimensions and other factors. Simultaneously, the computer/communication system activates modules m105, m107, m109, m111, m113 and m115 of respective rooms r105, r107, r109, r111, r113, and r115 into the first configuration as previously programmed for optimum speed and safety. Such configuration choice will be dictated by physical dimensions and other factors. Simultaneously the computer/communication system activates modules m106, m108, m110, m112, m114 and m116 of respective rooms r106, r108, r110, r112, r114, and r116 into the fourth configuration as previously programmed for optimum speed and safety. Such configuration choice will be dictated by physical dimensions and other factors.

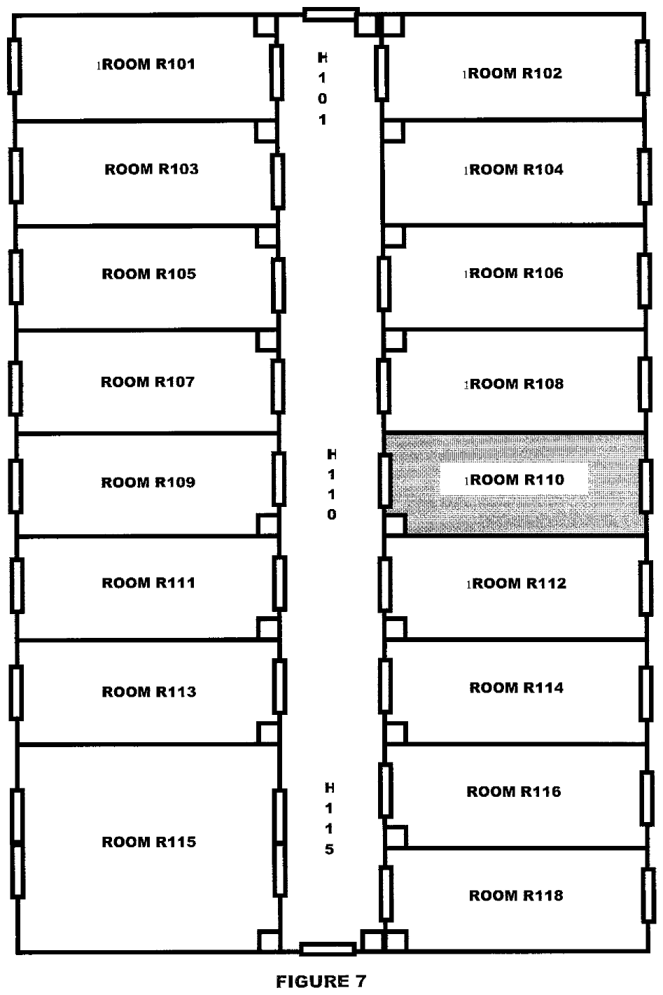

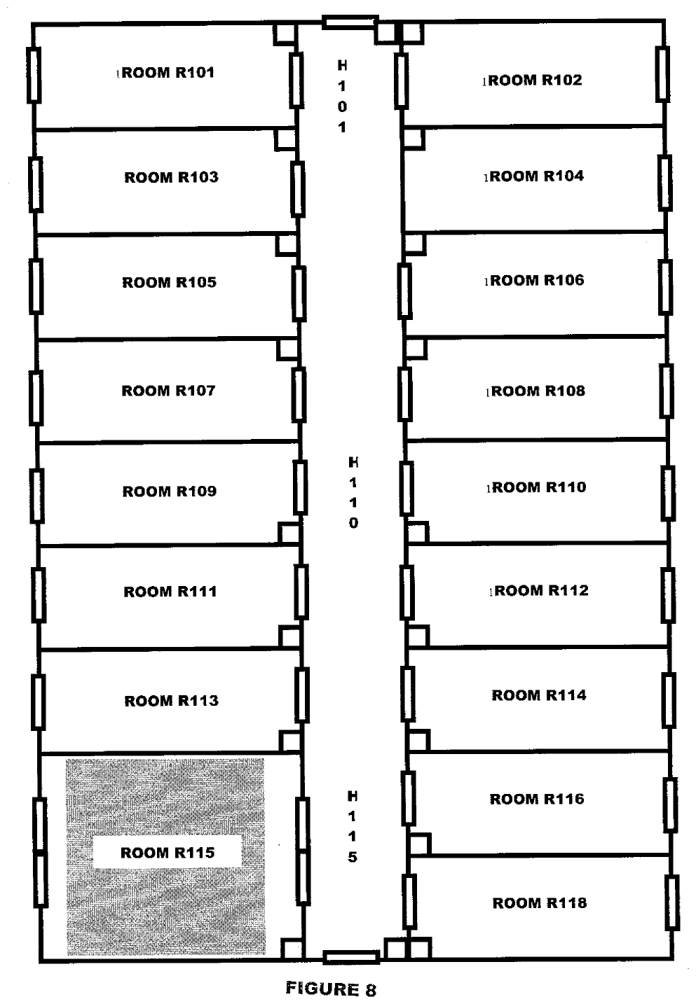

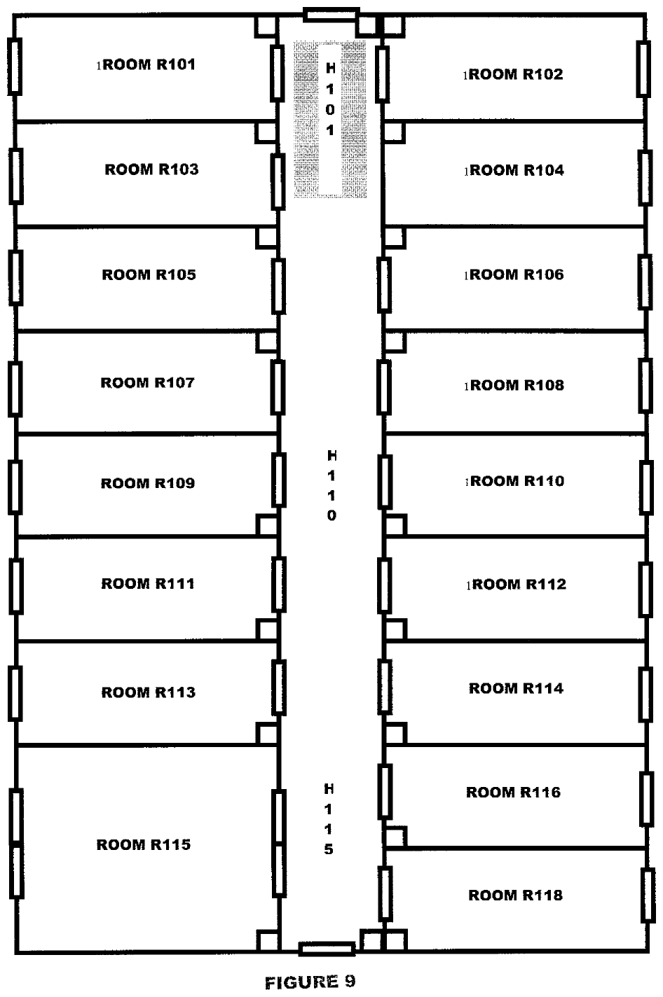

FIG. 7 shows the school premises and indicates that the audio sensing means of module m110 of room r110 in conjunction with the computer/communication system of room r118 has detected a second active-shooter event in room r110. In such case module m110 is activated by the computer/communication system into the first configuration for alerting and directing the occupants of room r110. Simultaneously, the computer/communication system activates module m109 of room r109 into the second configuration as previously programmed for optimum speed and safety. Such configuration choice will be dictated by physical dimensions and other factors. Simultaneously the computer/communication system activates module m108 of room r108 into the second configuration or the third configuration as previously programmed for optimum speed and safety. Such configuration choice will be dictated by physical dimensions and other factors. Simultaneously, the computer/communication system activates module m112 of room r112 into the second configuration or the fourth configuration as previously programmed for optimum speed and safety. Such configuration choice will be dictated by physical dimensions and other factors. Simultaneously, the computer/communication system activates modules m107 of room r107 the second configuration or the fourth configuration as previously programmed for optimum speed and safety. Such configuration choice will be dictated by physical dimensions and other factors. Simultaneously the computer/communication system activates modules m111 of room r11 into the second configuration or the third configuration as previously programmed for optimum speed and safety. Such configuration choice will be dictated by physical dimensions and other factors. Simultaneously, the computer/communication system activates modules m101, m103, and m105 respective rooms r101, r103, and r105 into the fourth configuration as previously programmed for optimum speed and safety. Such configuration choice will be dictated by physical dimensions and other factors. Simultaneously the computer/communication system activates modules m113 and m115 of respective rooms r113 and r115 into the third configuration as previously programmed for optimum speed and safety. Such configuration choice will be dictated by physical dimensions and other factors. Simultaneously, the computer/communication system activates modules m102, m104, and m106 in respective rooms r102, r104, and r106 into the third configuration as previously programmed for optimum speed and safety. Such configuration choice will be dictated by physical dimensions and other factors. Simultaneously, the computer/communication system activates modules m114, m116 and m118 of respective rooms r114 r116 and r118 into the fourth configuration as previously programmed for optimum speed and safety. Such configuration choice will be dictated by physical dimensions and other factors. FIG. 8 shows the school premises and indicates that the audio sensing means of module m115 of room r115 in conjunction with the computer/communication system of room r118 has detected a third active-shooter event in room r115. In such case, module m115 is activated by the computer/communication system into the first configuration for alerting and directing the occupants out of room r115. Simultaneously, the computer/communication system activates module m113 of room r113 into the second configuration as previously programmed for optimum speed and safety. Such configuration choice will be dictated by physical dimensions and other factors. Simultaneously, the computer/communication system activates module m118 of room r118 into the second configuration as previously programmed for optimum speed and safety. Such configuration choice will be dictated by physical dimensions and other factors. Simultaneously, the computer/communication system activates module m116 of room r116 into the second configuration as previously programmed for optimum speed and safety. Such configuration choice will be dictated by physical dimensions and other factors. Simultaneously, the computer/communication system activates module m113 of room r113 into the second configuration or the fourth configuration as previously programmed for optimum speed and safety. Such configuration choice will be dictated by physical dimensions and other factors. Simultaneously, the computer/communication system activates module m114 of room r114 into the third configuration as previously programmed for optimum speed and safety. Such configuration choice will be dictated by physical dimensions and other factors. Simultaneously, the computer/communication system activates modules m101, m103, m105, m107, m109 and mill of respective rooms r101, r103, r105, r107, r109 and r111 into the fourth configuration as previously programmed for optimum speed and safety. Such configuration choice will be dictated by physical dimensions and other factors. Simultaneously, the computer/communication system activates modules m102, m104, m106, m108, m110 and m112 of respective rooms r102, r104, r106, r108, r110 and r112 into the third configuration as previously programmed for optimum speed and safety. Such configuration choice will be dictated by physical dimensions and other factors. FIG. 9 shows the school premises and indicates that the audio sensing means of module h101 in conjunction with the computer/communication system of room r118 has detected a fourth active-shooter event at end h101 of the hallway. In such case room modules m101 through m118 are simultaneously activated by the computer/communication system into the second configuration for alerting and directing the occupants of rooms r101 through r118. Such configuration choice will be dictated by physical dimensions and other factors.

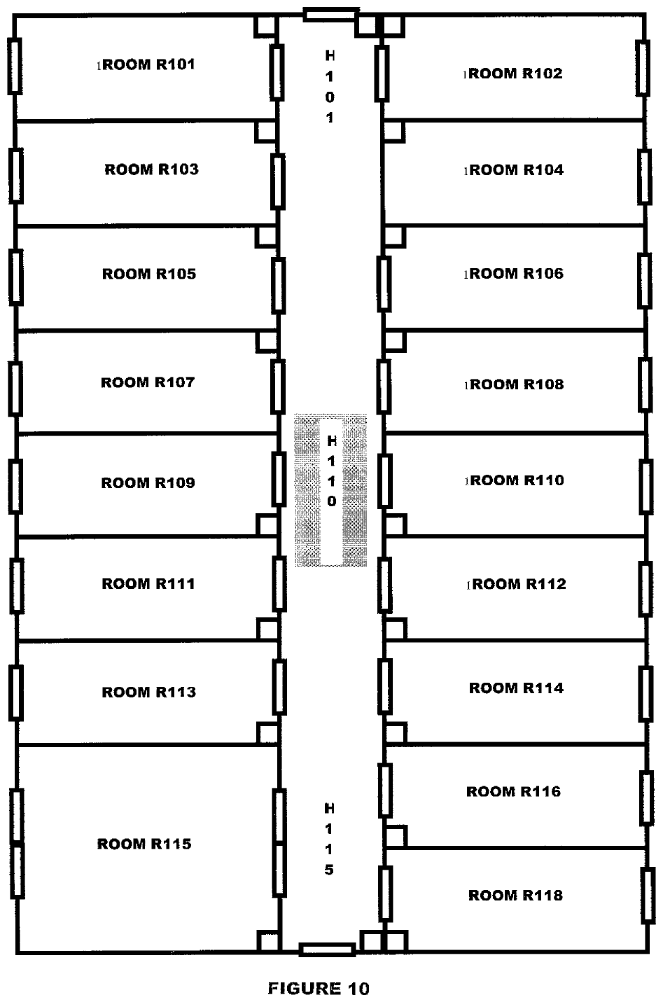

FIG. 10 shows the school premises and indicates that the audio sensing means of modules h101 and h115 in conjunction with the computer/communication system of room r118 has simultaneously detected a fifth active-shooter event at the middle h110 of the hallway. In such case room modules m101 through m118 are simultaneously activated by the computer/communication system into the second configuration for alerting and directing the occupants of rooms r101 through r118. Such configuration choice will be dictated by physical dimensions and other factors.

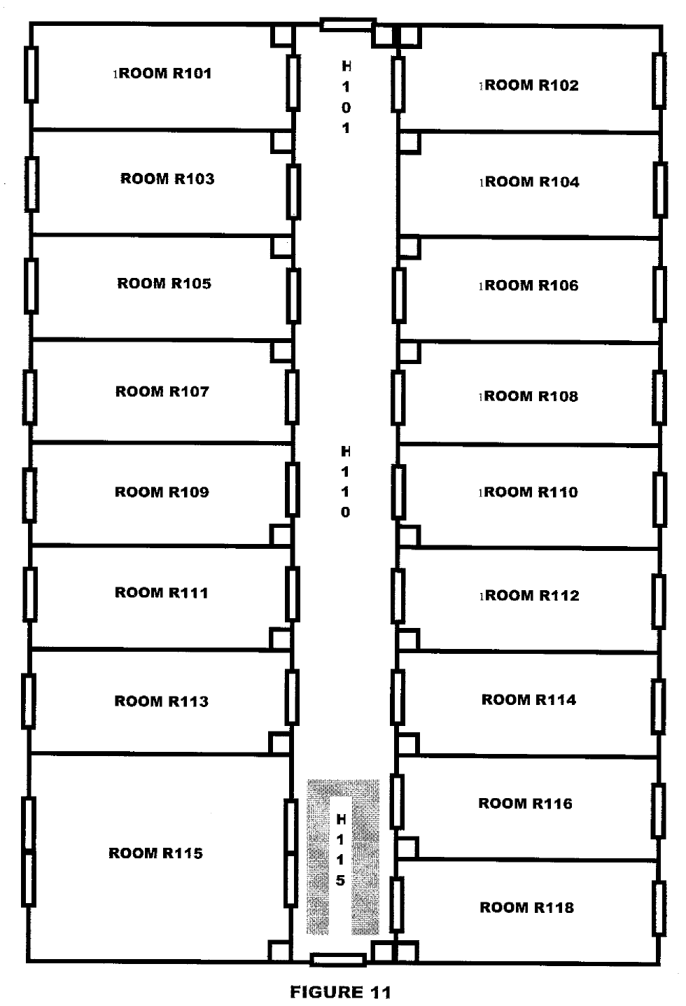

FIG. 11 shows the school premises and indicates that the audio sensing means of module h115 in conjunction with the computer/communication system of room r118 has detected a sixth active-shooter event at end h115 of the hallway. In such case room modules m101 through m118 are simultaneously activated by the computer/communication system into the second configuration for alerting and directing the occupants of rooms r101 through r118. Such configuration choice will be dictated by physical dimensions and other factors.

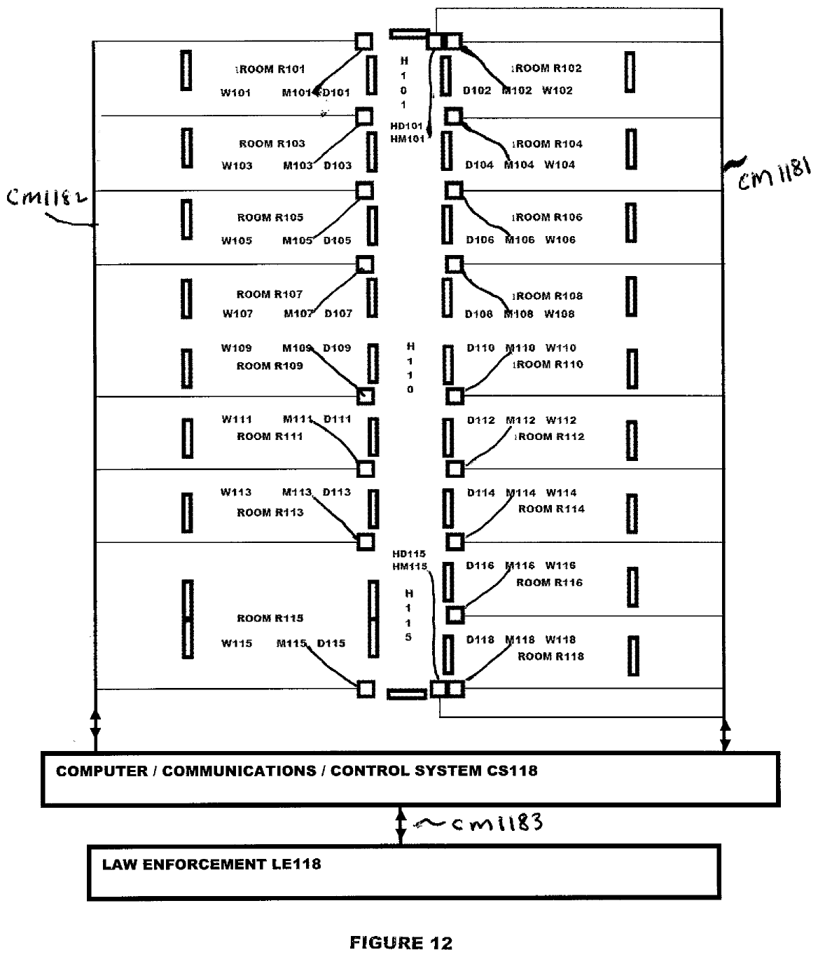

FIG. 12 shows the connections between modules m101 through m118, hm101 and hm115 to control system cs118 of room 118. Modules m102, m104, m106, m108, m110, m112, m114, m118, hm101 and hm115 are connected via bi-directional communications means cm1181 to control system cs118 of room 118. Modules m101, m103, m105, m107, m109, mill, m113, and m115 are connected via bi-directional communications means cm1182 to control system cs118 of room 118. Further control system cs118 of room 118 is connected via bi-directional communications means cm1183 to law enforcement le 118. The aforementioned configurations of modules m101 through m118 may change as the active-shooter events progress physically throughout the premises. Such progression of active-shooter events are detected by the respective proximate modules in order and such detections are transmitted in order to control system cs118. In turn, control system cs118 receives such module detections and effects changes in the module configurations as pre-programmed in control system cs118. Upon the detection of each consecutive active-shooter event, control system cs118 transmits a unique code to law enforcement via communications means cm1183 thereby allowing law enforcement le118 to enter control system cs118 and directing law enforcement le118 to the current active-shooter scene via the audio sensing means and the video sensing means of the current active module.

While the present invention has been described in terms of specific illustrative embodiments, it will be apparent to those skilled in the art that many other embodiments and modifications are possible within the spirit and scope of the disclosed principles.

What is claimed is:

1. A method for responding to an active-shooter event in a premises comprising the steps of:
a. Providing a module in each room and each designated area of such premises, each said module being controlled and monitored by a remote computer/communications/control system;
b. Each said module providing audio sensing means;
c. Said control system remotely configuring each said module to project or display via a screen or monitor a command or commands in response to an active-shooter event detected by the audio sensing means of a module hereinafter known as the activated module;
d. Said control system transmitting to law enforcement a unique code thereby allowing law enforcement to enter said control system and thereby allowing law enforcement to monitor and assess said activated module.

2. A method for responding to serial active-shooter events in a premises comprising the steps of:
a. Providing a module in each room and each designated area of such premises; each said module being controlled and monitored by a remote computer/communications/control system;
b. Each said module providing audio sensing means;
c. Said control system remotely configuring and re-configuring each said module to project or display via a screen or a monitor a command or commands in response to serial active-shooter events detected by the audio sensing means of serially activated modules;
d. Said control system transmitting to law enforcement serial unique codes thereby allowing law enforcement to enter said control system and thereby allowing law enforcement to monitor and assess said serially activated modules.

3. The method of claim 1 further comprising the steps of:
a. Each said module further providing: audio alarm means; video sensing means; and motion sensing means;
b. Said control system remotely configuring each said module to project or display via a screen or a monitor a “left exit” command; and/or a “right exit” command; and/or a “window exit” command; and/or audio commands; and/or other commands in response to an active-shooter event detected by the audio sensing means of a module hereinafter known as the activated module;
c. Said control system transmitting to law enforcement a unique code thereby allowing law enforcement to enter said control system and thereby allowing law enforcement to monitor and assess said activated module via its audio sensing means; and/or its video sensing means; and/or its motion sensing means.

4. The method of claim 2 further comprising the steps of:
a. Each said module further providing: audio alarm means; video sensing means; and motion sensing means;
b. Said control system remotely configuring and re-configuring each said module to project or display via a screen or a monitor a “left exit” command; and/or a “right exit” command; and/or a “window exit” command; and/or an audio command; and/or other commands in response to serial active-shooter events detected by the audio response means of serially activated modules; and
c. Said control system transmitting to law enforcement serial unique codes thereby allowing law enforcement to enter said control system and thereby allowing law enforcement to monitor and assess said serially activated modules via their audio sensing means; and/or their video sensing means; and/or their motion sensing means.
